(19) United States
(12) Patent Application Publication
(10) Pub. No.: US 2022/0126743 A1
(43) Pub. Date: Apr. 28, 2022

(54) TANK TRAILER AND METHOD OF MANUFACTURING SAME

(71) Applicant: Wabash National, L.P., Lafayette, IN (US)

(72) Inventors: Bryan Yielding, Riceville, TN (US); Jian Feng Tong, Dallas, TX (US)

(21) Appl. No.: 17/502,305

(22) Filed: Oct. 15, 2021

Related U.S. Application Data
(60) Provisional application No. 63/104,846, filed on Oct. 23, 2020.

(51) Int. Cl. B60P 3/22; B62D 53/06

(52) U.S. Cl. CPC B60P 3/221; B62D 53/06

(57) ABSTRACT

A tank trailer for transporting cargo material includes a tank, and the tank includes a wall portion that defines a longitudinal axis of the tank and an internal chamber adapted to carry the cargo material. The wall portion includes a first sidewall, and the first sidewall includes a first cross-sectional radius of curvature that tapers proceeding in a direction parallel to the longitudinal axis. The wall portion further includes a second sidewall and a third wall. The third wall is coupled to the first sidewall and the second sidewall, and the third wall includes a second cross-sectional radius of curvature that is substantially uniform proceeding in a direction parallel to the longitudinal axis.

### CROSS-REFERENCE TO RELATED APPLICATION

The present application claims the benefit of and priority to, under 35 U.S.C. § 119(e), U.S. Provisional Application Ser. No. 63/104,846, filed on Oct. 23, 2020, which is hereby incorporated herein by reference in its entirety for all that it teaches and for all purposes.

### FIELD OF THE DISCLOSURE

The present disclosure relates generally to tank trailers for transporting liquids, such as petroleum. More particularly, the present disclosure relates to trailers having tapering, “deep drop” tanks.

### BACKGROUND OF THE DISCLOSURE

Tank trailers are used in the transportation industry for transporting various types of cargo materials. Some tank trailers are used to transport liquids, including petroleum. Such tank trailers typically include an elongated vessel or tank for carrying liquids, and the walls of the tank typically comprise a relatively strong and durable material (for example, steel or aluminum) to withstand both exterior demands (for example, weather, road conditions, other vehicles) and interior demands (for example, cargo weight). In recent years, tank shapes have been modified to improve performance. For example, tank shapes have been modified to increase cargo capacity, cargo discharge rates, and fuel efficiency. However, tanks having such shapes are difficult to manufacture and, as a result, relatively expensive. Accordingly, improved tank trailers are needed.

### SUMMARY OF THE DISCLOSURE

Embodiments of the present disclosure are directed to tank trailers for transporting cargo material. In some embodiments, tank trailers of the present disclosure have shapes that provide various advantages including, for example, having a relatively high capacity despite having a relatively compact profile, the ability to quickly and more completely dispense cargo materials, improved stability and maneuvering, and ease of manufacturing.

An exemplary embodiment of the present disclosure is directed to a tank trailer for transporting cargo material. The tank trailer includes a chassis and a plurality of wheels coupled to the chassis. A tank is coupled to the chassis, and the tank includes a wall portion that defines a longitudinal axis of the tank and an internal chamber adapted to carry the cargo material. The wall portion includes a first sidewall, and the first sidewall includes a first cross-sectional radius of curvature that tapers proceeding in a direction parallel to the longitudinal axis. The wall portion further includes a second sidewall and a third wall. The third wall is coupled to the first sidewall and the second sidewall, and the third wall includes a second cross-sectional radius of curvature that is substantially uniform proceeding in a direction parallel to the longitudinal axis.

Another exemplary embodiment of the present disclosure is directed to a tank trailer for transporting cargo material. The tank trailer includes a chassis and a plurality of wheels coupled to the chassis. The tank trailer further includes a tank coupled to the chassis. The tank includes a wall portion defining a longitudinal axis of the tank and an internal chamber adapted to carry the cargo material. The wall portion includes an upper wall and a first sidewall coupled to the upper wall at a first seam. The first sidewall includes a first cross-sectional radius of curvature that tapers proceeding in a direction parallel to the longitudinal axis. The wall portion further includes a second sidewall coupled to the upper wall at a second seam opposite the first seam. The second sidewall includes a second cross-sectional radius of curvature that tapers proceeding in the direction parallel to the longitudinal axis. The wall portion further includes a lower wall coupled to the first sidewall at a third seam and the second sidewall at a fourth seam opposite the third seam.

Yet another exemplary embodiment of the present disclosure is directed to a method of manufacturing a tank trailer for carrying cargo material. The method includes forming a tank, which includes providing a first sidewall preform, a second sidewall preform, an upper wall preform, and a lower wall preform; coupling the first sidewall preform to the upper wall preform at a first seam; coupling the upper wall preform to the second sidewall preform at a second seam; coupling the second sidewall preform to the lower wall preform at a third seam; shaping the first sidewall preform, the upper wall preform, the second sidewall preform, and the lower wall preform to provide a tank section preform including a longitudinal axis. Shaping the preforms includes rolling the first sidewall preform to provide the tank section preform with a first sidewall including a first cross-sectional radius of curvature that tapers proceeding in a direction parallel to the longitudinal axis; rolling at least one of the upper wall preform and the lower wall preform to provide the tank section preform with at least one of an upper wall and a lower wall including a second cross-sectional radius of curvature that is substantially uniform proceeding in the direction parallel to the longitudinal axis. The method further includes mounting the tank to a chassis.

Yet another exemplary embodiment of the present disclosure is directed to a method of manufacturing a plurality of tank trailers. The method includes forming a first tank, which includes providing a first plurality of wall preforms and coupling the first plurality of wall preforms to each other at a plurality of first seams. The first plurality of wall preforms are shaped to provide a first tank section preform that includes a first longitudinal axis and a first length in a first direction parallel to the first longitudinal axis. Shaping the first plurality of preforms includes rolling at least one of the first plurality of preforms to provide the first tank section preform with a first cross-sectional radius of curvature that is substantially uniform proceeding in the first direction parallel to the first longitudinal axis. The method further includes mounting the first tank to a first chassis and forming a second tank, which includes providing a second plurality of wall preforms and coupling the second plurality of wall preforms to each other at a plurality of second seams. The second plurality of wall preforms are shaped to provide a second tank section preform including a second longitudinal axis and a second length in a second direction parallel to the second longitudinal axis, and the second length is different than the first length. Shaping the second plurality of preforms includes rolling at least one of the second plurality of preforms to provide the second tank section preform with a second cross-sectional radius of curvature that is substantially uniform proceeding in the second direction parallel to the second longitudinal axis. The second cross-sectional radius of curvature is equal to the first cross-sectional radius of curvature. The method further includes mounting the second tank to a second chassis.

Additional features and advantages of the present invention will become apparent to those skilled in the art upon consideration of the following detailed description of the illustrative embodiments exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1 is a perspective view of a tank trailer according to an exemplary embodiment of the present invention coupled to a truck;

FIG. 2 is another perspective view of the tank trailer of FIG. 1; a tank of the tank trailer is shown in phantom lines to illustrate internal components;

FIG. 3 is a top front perspective view of a wall portion of the tank trailer of FIG. 1;

FIG. 4 is a bottom front perspective view of the wall portion of the tank trailer of FIG. 1;

FIG. 5 is a top rear perspective view of the wall portion of the tank trailer of FIG. 1;

FIG. 6 is a bottom rear perspective view of the wall portion of the tank trailer of FIG. 1;

FIG. 7 is a left side view of the wall portion of the tank trailer of FIG. 1;

FIG. 8 is a right side view of the wall portion of the tank trailer of FIG. 1;

FIG. 9 is a cross-sectional view of a front portion of the wall portion along line 9-9 of FIG. 7;

FIG. 10 is a cross-sectional view of the front portion of the wall portion along line 10-10 of FIG. 7;

FIG. 11 is a cross-sectional view of the front portion of the wall portion along line 11-11 of FIG. 7;

FIG. 12 is a composite cross-sectional view including the cross sections of the front portion of the wall portion along lines 9-9, 10-10, and 11-11 of FIG. 7;

FIG. 13 is a cross-sectional view of a rear portion of the wall portion along line 13-13 of FIG. 8;

FIG. 14 is a cross-sectional view of the rear portion of the wall portion along line 14-14 of FIG. 8;

FIG. 15 is a cross-sectional view of the rear portion of the wall portion along line 15-15 of FIG. 8;

FIG. 16 is a composite cross-sectional view including the cross sections of the front portion of the wall portion along lines 13-13, 14-14, and 15-15 of FIG. 8;

FIG. 17 is a top view of a flat preform for a first sidewall of the front portion of the wall portion;

FIG. 18 is a top view of a flat preform for an upper wall of the front portion of the wall portion;

FIG. 19 is a top view of a flat preform for a second sidewall of the front portion of the wall portion;

FIG. 20 is a top view of a flat preform for a lower wall of the front portion of the wall portion;

FIG. 21 is a top view of a flat preform for a first sidewall of the rear portion of the wall portion;

FIG. 22 is a top view of a flat preform for an upper wall of the rear portion of the wall portion;

FIG. 23 is a top view of a flat preform for a second sidewall of the rear portion of the wall portion;

FIG. 24 is a top view of a flat preform for a lower wall of the rear portion of the wall portion;

FIG. 25 is a top view of a flat preform for the front portion of the wall portion;

FIG. 26 is a top view of a flat preform for the rear portion of the wall portion;

FIG. 27 is a side view of the tank trailer and the truck of FIG. 1 illustrating size profiles thereof;

FIG. 28 is a rear view of the tank trailer and the truck of FIG. 1 illustrating the size profiles thereof; and

FIG. 29 is a bottom perspective view of the wall portion, outriggers, and crossmembers of the tank trailer of FIG. 1.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

For the purposes of promoting an understanding of the principals of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

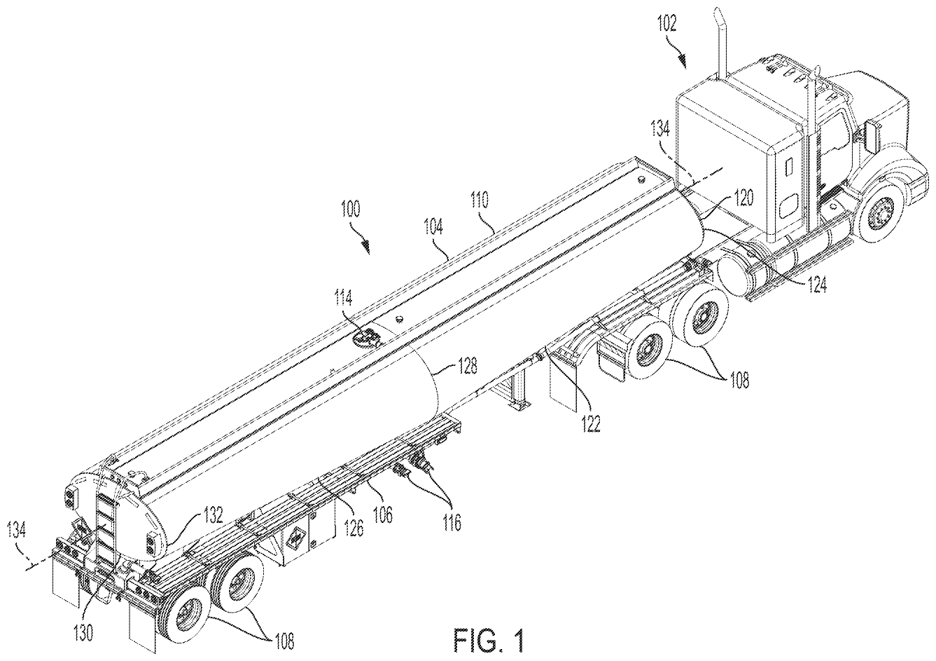

FIG. 1 illustrates a tank trailer 100 according to an exemplary embodiment of the present invention coupled to a conventional truck 102. The trailer 100 generally includes a tank 104 for receiving and transporting cargo materials including, for example, liquids such as petroleum. The tank 104 is supported by a chassis 106, and a plurality of wheels 108 are mounted to the chassis 106. A hitch (not shown) is also mounted to the chassis 106, and the hitch facilitates coupling the tank trailer 100 to the truck 102. As described in further detail below, the tank 104 has a shape that provides various advantages including, for example, having a relatively high capacity despite having a relatively compact profile, the ability to quickly and more completely dispense cargo materials, improved stability and maneuvering, and ease of manufacturing.

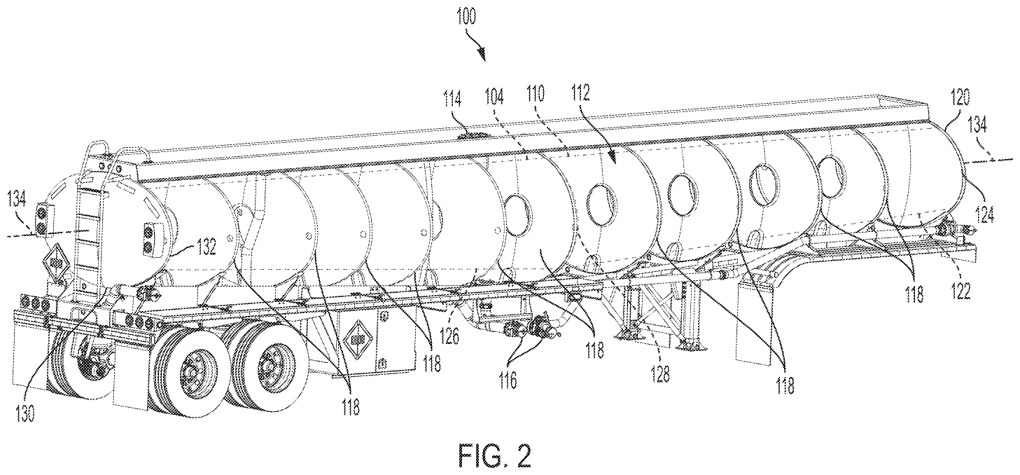

With continued reference to FIG. 1 and additional reference to FIG. 2, the tank 104 includes a wall portion 110 that defines one or more internal chambers 112 (illustratively, one internal chamber 112; FIG. 2) for carrying cargo material. The internal chamber 112 is coupled to one or more selectively openable and closeable inlets 114 (illustratively, one inlet 114) and one or more selectively openable and closeable outlets 116 (illustratively, two outlets 116) for receiving and dispensing cargo materials, respectively. The internal chamber 112 houses a plurality of internal supports 118 (FIG. 2), also referred to as heads, for supporting the wall portion 110. The wall portion 110 may comprise various appropriate materials including, for example, metals such as aluminum or steel. Generally, the wall portion 110 includes a first or front endwall 120, a first or front portion 122 coupled to the front endwall 120 at a first or front seam 124, a second or rear portion 126 coupled to the front portion 122 at a second or intermediate seam 128 opposite the front seam 124, and a second or rear endwall 130 coupled to the rear portion 126 at a third or rear seam 132 opposite the intermediate seam 128. The front seam 124, the intermediate seam 128, and the rear seam 132 include welded connections (not shown) that join the adjacent components of the wall portion 110. The wall portion 110 also defines a longitudinal axis 134 of the tank 104. More specifically, the longitudinal axis 134 intersects with the front endwall 120 and the rear endwall 130, and the front portion 122 and the rear portion 126 are elongated in directions parallel to the longitudinal axis 134.

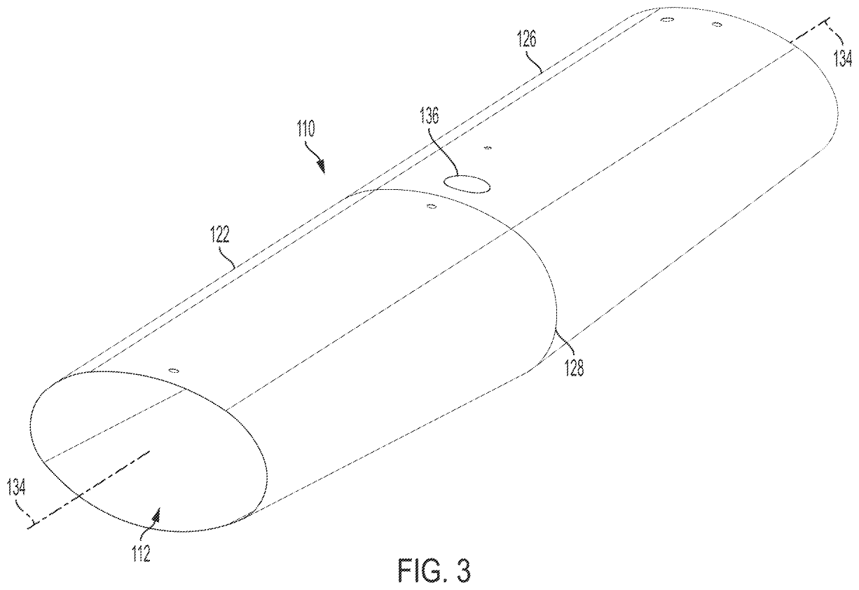

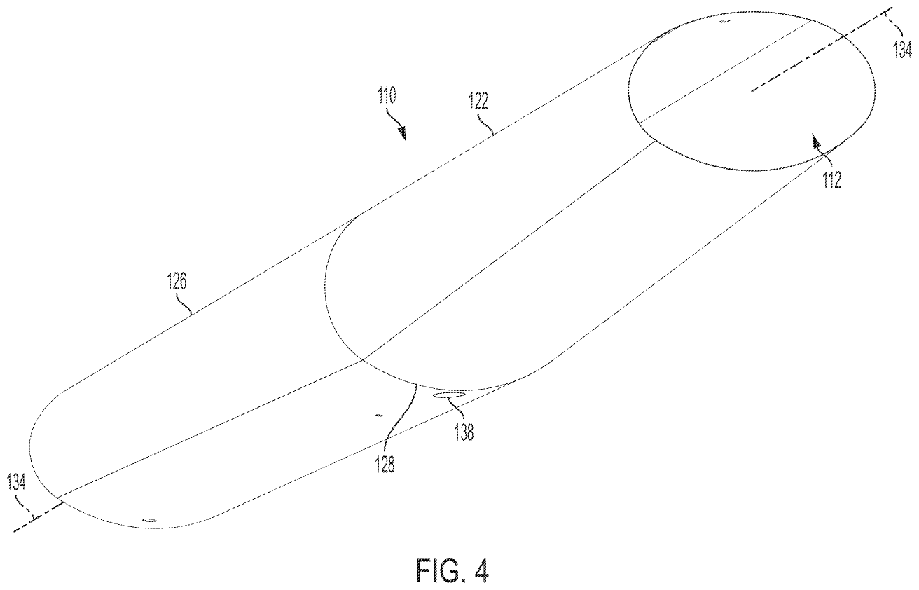

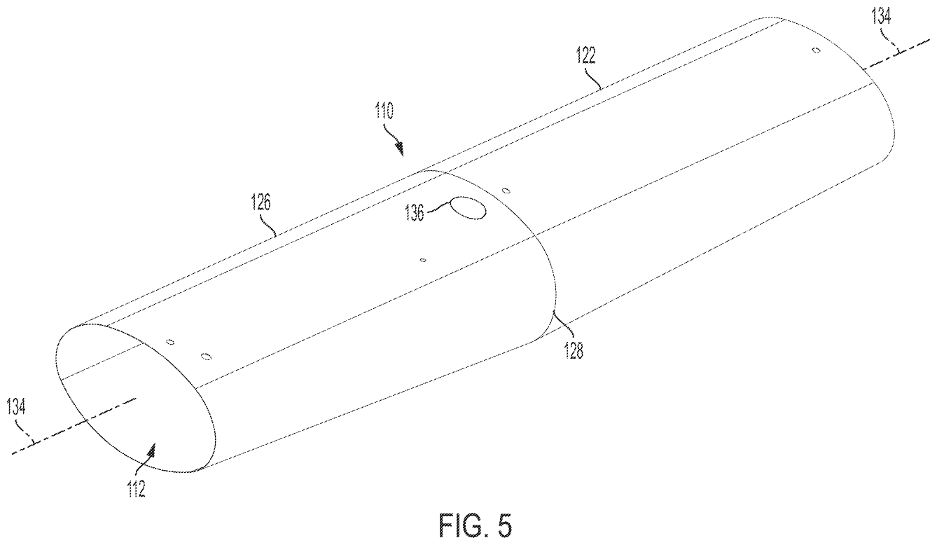

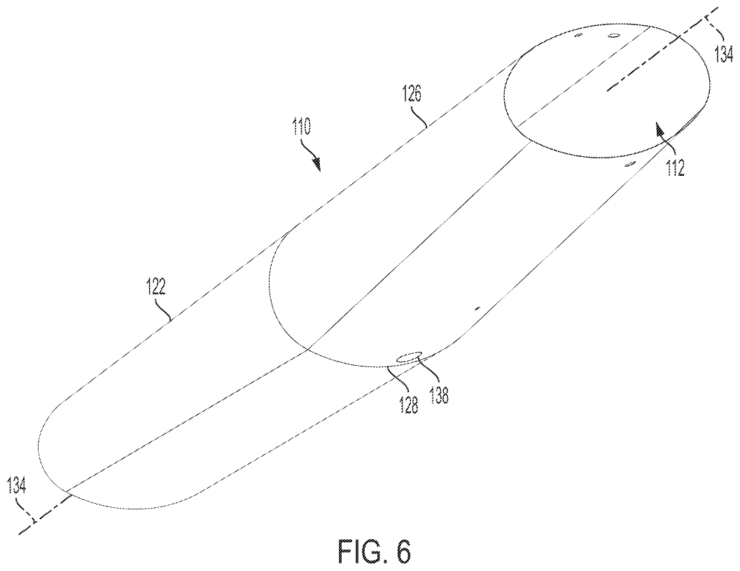

FIGS. 3-8 illustrate the wall portion 110 of the tank 104 separate from other components of the tank 104. Generally, the front portion 122 and the rear portion 126 of the wall portion 110 have frustoconical-like shapes that meet at their wider bases. Stated another way, the front portion 122 and the rear portion 126 of the wall portion 110 have ellipse-like, tapering or decreasing cross-sectional areas proceeding away from each other along the longitudinal axis 134. Stated yet another way, the front portion 122 and the rear portion 126 of the wall portion 110 have ellipse-like, increasing cross-sectional areas proceeding toward each other along the longitudinal axis 134. Similarly, the internal chamber 112 has a maximum cross-sectional area at the interface between the front portion 122 and the rear portion 126 (that is, at the intermediate seam 128). The front portion 122 and the rear portion 126 also provide the internal chamber 112 with a lowest point at the interface between the front portion 122 and the rear portion 126 (that is, at the intermediate seam 128). In the illustrated embodiment, the front portion 122 and the rear portion 126 are substantially mirror images of each other (that is, except for features including one or more inlet openings 136 and one or more outlet openings 138 on the rear portion 126). In other embodiments, the front portion 122 and the rear portion 126 are not substantially mirror images of each other. More specifically, the front portion 122 and the rear portion 126 may have different lengths along the longitudinal axis 134 provided that they have a substantially similar shape at the intermediate seam 128.

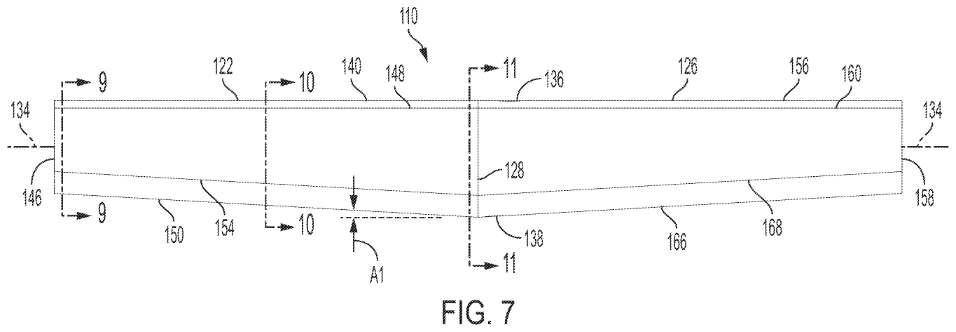

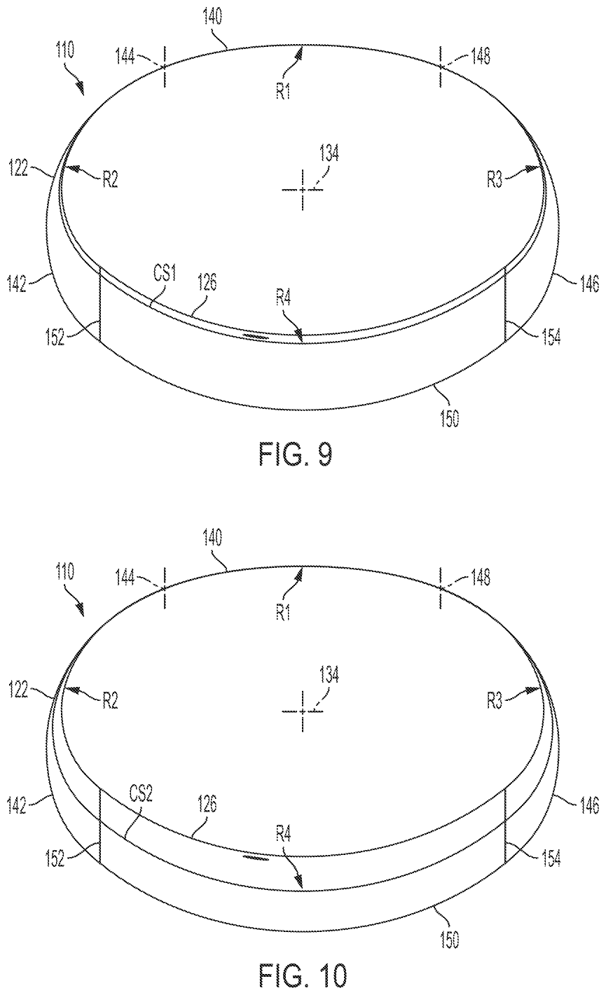

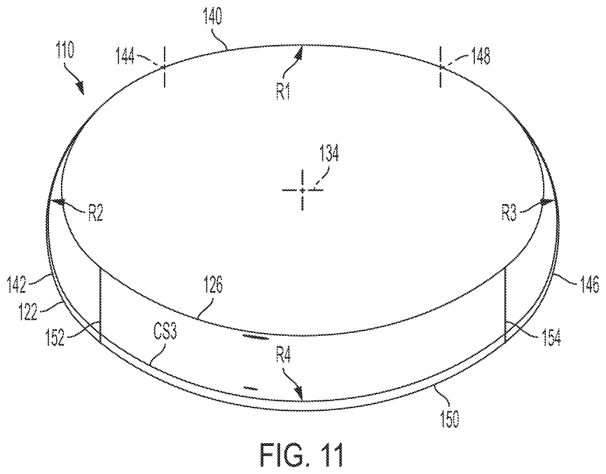

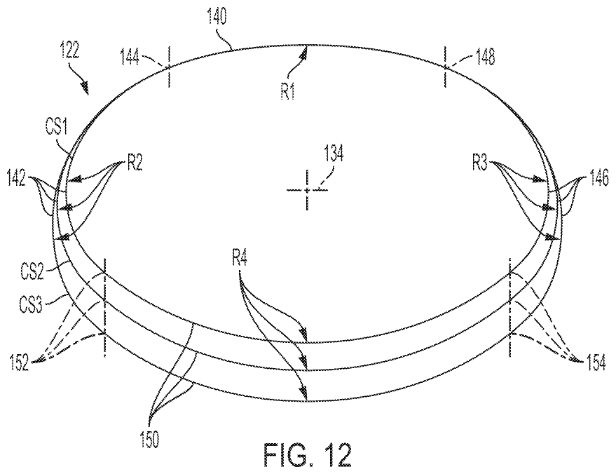

Referring now to FIGS. 7-12, the front portion 122 of the wall portion 110 is illustrated in further detail. FIG. 9 illustrates a cross section CS1 of the front portion 122 at a first location, FIG. 10 illustrates a cross section CS2 of the front portion 122 at a second location, FIG. 11 illustrates a cross section CS3 of the front portion 122 at a third location, and FIG. 12 is a composite view including the cross sections CS1, CS2, and CS3 shown in FIGS. 9-11. Generally, the front portion 122 includes a plurality of walls that together provide the front portion 122 with its ellipse-like cross-sectional shape. More specifically, the front portion 122 includes an upper wall 140, a first (i.e., curbside) sidewall 142 coupled to the upper wall 140 at a first seam 144, a second (i.e., roadside) sidewall 146 coupled to the upper wall 140 at a second seam 148 opposite the first seam 144, and a lower wall 150 coupled to the first sidewall 142 at a third seam 152 and coupled to the second sidewall 146 at a fourth seam 154 opposite the third seam 152. The first seam 144, the second seam 148, the third seam 152, and the fourth seam 154 include welded connections (not shown) that join the adjacent walls of the front portion 122. In other embodiments, one or more of the upper wall 140, the first sidewall 142, the second sidewall 146, and the lower wall 150 may be integrally coupled to, or monolithically formed with, each other. The front portion 122 may have a varying wall thickness. For example, the lower wall 150 may have a relatively high wall thickness, the sidewalls 142, 146 may have an intermediate wall thickness, and the upper wall 140 may have a relatively low wall thickness.

The upper wall 140 of the front portion 122 has a substantially uniform (that is, equal ±5 percent) cross-sectional radius of curvature R1 in a direction parallel to the longitudinal axis 134. Stated another way, the radius of curvature R1 of the upper wall 140 is substantially the same (that is, equal ±5 percent) in each cross section along the longitudinal axis 134, including the cross sections CS1, CS2, and CS3 illustrated in FIGS. 9-11. Stated yet another way, the upper wall 140 has a partial cylindrical shape or a cylindrical radius. The substantially uniform cross-sectional radius of curvature R1 also provides the upper wall 140 with a substantially uniform arc length. As a result, the upper wall 140 may be advantageously manufactured from a substantially rectangular shape, as described in further detail below. The upper wall 140 is substantially parallel (that is, parallel ±1.5 degrees) to the longitudinal axis 134 and to the ground.

The first sidewall 142 of the front portion 122 has a cross-sectional radius of curvature R2 that tapers proceeding in a forward direction parallel to the longitudinal axis 134 and away from the rear portion 126. As illustrated, the radius R2 of curvature may decrease linearly proceeding away from the rear portion 126. Stated another way, the first sidewall 142 has a partial frustoconical-like shape or conic radius.

The second sidewall 146 may be a substantially mirror image of the first sidewall 142. That is, the second sidewall 146 of the front portion 122 has a cross-sectional radius of curvature R3 that tapers proceeding in a forward direction parallel to the longitudinal axis 134 and away from the rear portion 126. As illustrated, the radius of curvature R3 may decrease linearly proceeding away from the rear portion 126. Stated another way, the second sidewall 146 has a partial frustoconical-like shape or conic radius.

The lower wall 150 of the front portion 122 has a substantially uniform (that is, equal ±5 percent) cross-sectional radius of curvature R4 in a direction parallel to the longitudinal axis 134. Stated another way, the radius of curvature R4 of the lower wall 150 is substantially the same (that is, equal ±5 percent) in each cross section along the longitudinal axis 134, including the cross sections CS1, CS2, and CS3 illustrated in FIGS. 9-11 (in contrast, the radius of curvature of a lower portion of other tank trailers differs in each cross section along the longitudinal axis). Stated yet another way, the lower wall 150 has a partial cylindrical shape or a cylindrical radius. The substantially uniform cross-sectional radius of curvature R4 also provides the lower wall 150 with a substantially uniform arc length. As a result, the lower wall 150 may be advantageously manufactured from a substantially rectangular shape, as described in further detail below. The lower wall 150 is disposed at an acute angle A1 (FIG. 7) relative to the longitudinal axis 134. In the illustrated embodiment, the acute angle A1 is substantially 3 degrees (that is, 3 degrees±0.5 degrees).

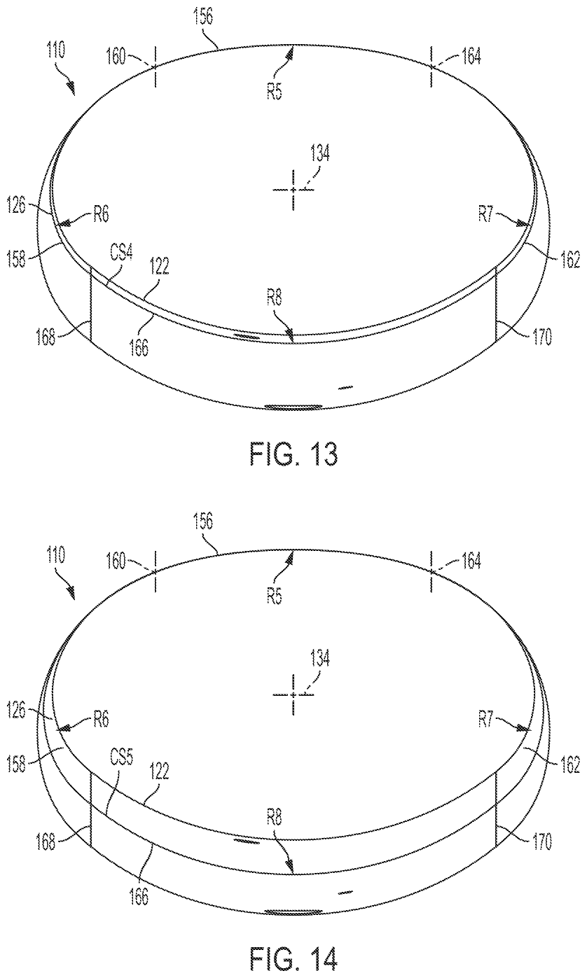

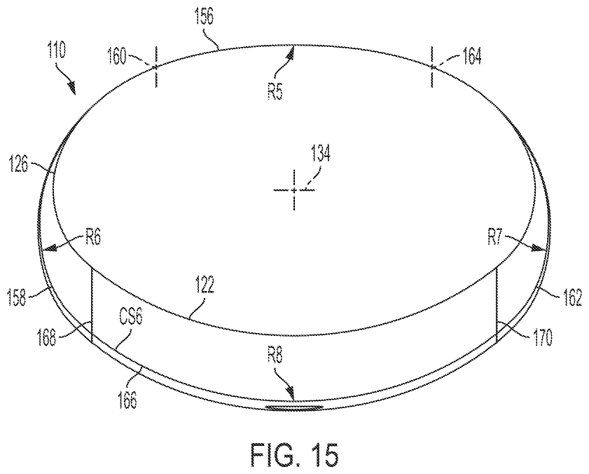

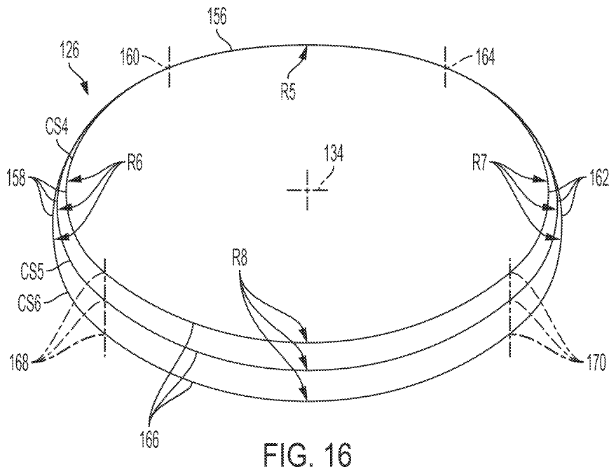

Referring now to FIGS. 7, 8, and 13-16, the rear portion 126 of the wall portion 110 is illustrated in further detail. FIG. 13 illustrates a cross section CS4 of the rear portion 126 at a first location, FIG. 14 illustrates a cross section CS5 of the rear portion 126 at a second location, FIG. 15 illustrates a cross section CS6 of the rear portion 126 at a third location, and FIG. 16 is a composite view including the cross sections CS4, CS5, and CS6 shown in FIGS. 13-15. Generally, the rear portion 126 includes a plurality of walls that together provide the rear portion 126 with its ellipse-like cross-sectional shape. More specifically, the rear portion 126 includes an upper wall 156, a first (i.e., roadside) sidewall 158 coupled to the upper wall 156 at a first seam 160, a second (i.e., curbside) sidewall 162 coupled to the upper wall 156 at a second seam 164 opposite the first seam 160, and a lower wall 166 coupled to the first sidewall 158 at a third seam 168 and coupled to the second sidewall 162 at a fourth seam 170 opposite the third seam 168. The first seam 160, the second seam 164, the third seam 168, and the fourth seam 170 include welded connections (not shown) that join the adjacent walls of the rear portion 126. In other embodiments, one or more of the upper wall 156, the first sidewall 158, the second sidewall 162, and the lower wall 166 may be integrally coupled to, or monolithically formed with, each other. The front portion 122 may have a varying wall thickness. The rear portion 126 may have a varying wall thickness. For example, the lower wall 166 may have a relatively high wall thickness, the sidewalls 158, 162 may have an intermediate wall thickness, and the upper wall 156 may have a relatively low wall thickness.

The upper wall 156 of the rear portion 126 has a substantially uniform (that is, equal ±5 percent) cross-sectional radius of curvature R5 in a direction parallel to the longitudinal axis 134. Stated another way, the radius of curvature R5 of the upper wall 156 is substantially the same (that is, equal ±5 percent) in each cross section along the longitudinal axis 134, including the cross sections CS4, CS5, and CS6 illustrated in FIGS. 13-15. Stated yet another way, the upper wall 156 has a partial cylindrical shape or a cylindrical radius. The substantially uniform cross-sectional radius of curvature R5 also provides the upper wall 156 with a substantially uniform arc length. As a result, the upper wall 156 may be advantageously manufactured from a substantially rectangular shape, as described in further detail below. The upper wall 156 is substantially parallel (that is, parallel ±1.5 degrees) to the longitudinal axis 134 and to the ground.

The first sidewall 158 of the rear portion 126 has a cross-sectional radius of curvature R6 that tapers proceeding in a rearward direction parallel to the longitudinal axis 134 and away from the front portion 122. As illustrated, the radius of curvature R6 may decrease linearly proceeding away from the front portion 122. Stated another way, the first sidewall 158 has a partial frustoconical-like shape or conic radius.

The second sidewall 162 may be a substantially mirror image of the first sidewall 158. That is, the second sidewall 162 of the rear portion 126 has a cross-sectional radius of curvature R7 that tapers proceeding in a rearward direction parallel to the longitudinal axis 134 and away from the front portion 122. As illustrated, the radius of curvature R7 may decrease linearly proceeding away from the front portion 122. Stated another way, the second sidewall 162 has a partial frustoconical-like shape or conic radius.

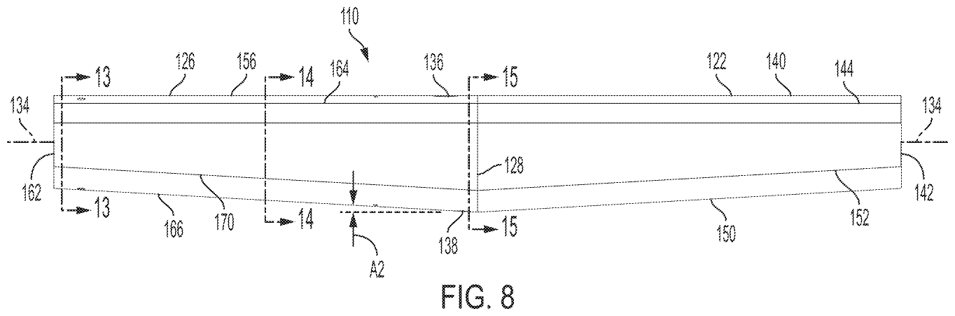

The lower wall 166 of the rear portion 126 has a substantially uniform (that is, equal ±5 percent) cross-sectional radius of curvature R8 in a direction parallel to the longitudinal axis 134. Stated another way, the radius of curvature R8 of the lower wall 166 is substantially the same (that is, equal ±5 percent) in each cross section along the longitudinal axis 134, including the cross sections CS4, CS5, and CS6 illustrated in FIGS. 13-15 (in contrast, the radius of curvature of a lower portion of other tank trailers differs in each cross section along the longitudinal axis). Stated yet another way, the lower wall 166 has a partial cylindrical shape or a cylindrical radius. The substantially uniform cross-sectional radius of curvature R8 also provides the lower wall 166 with a substantially uniform arc length. As a result, the lower wall 166 may be advantageously manufactured from a substantially rectangular shape, as described in further detail below. The lower wall 166 is disposed at an acute angle A2 (FIG. 8) relative to the longitudinal axis 134. In the illustrated embodiment, the acute angle A2 is substantially 3 degrees (that is, 3 degrees±0.5 degrees).

A method of manufacturing the tank trailer 100, more specifically the tank 104, according to an exemplary embodiment of the present invention is as follows.

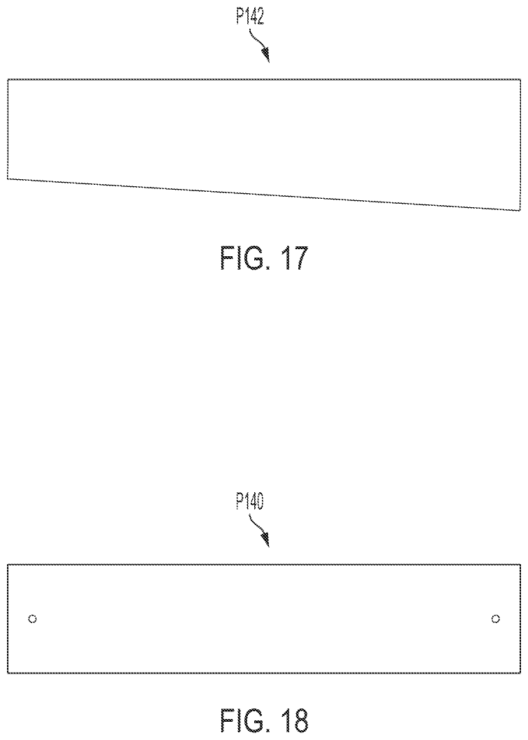

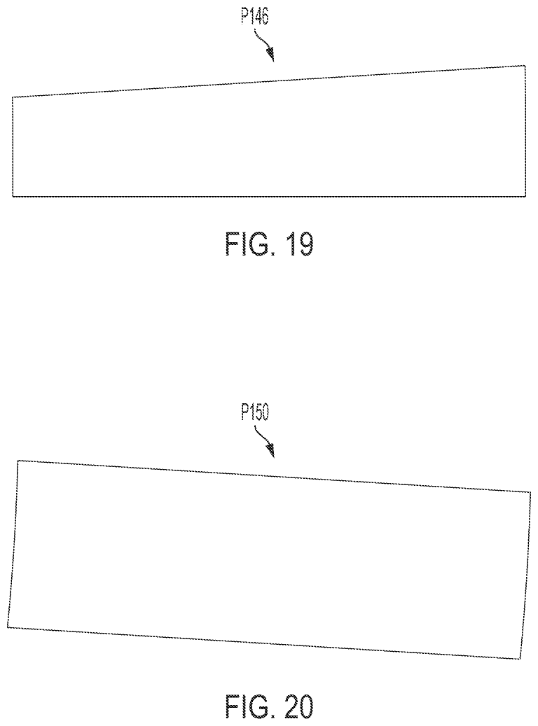

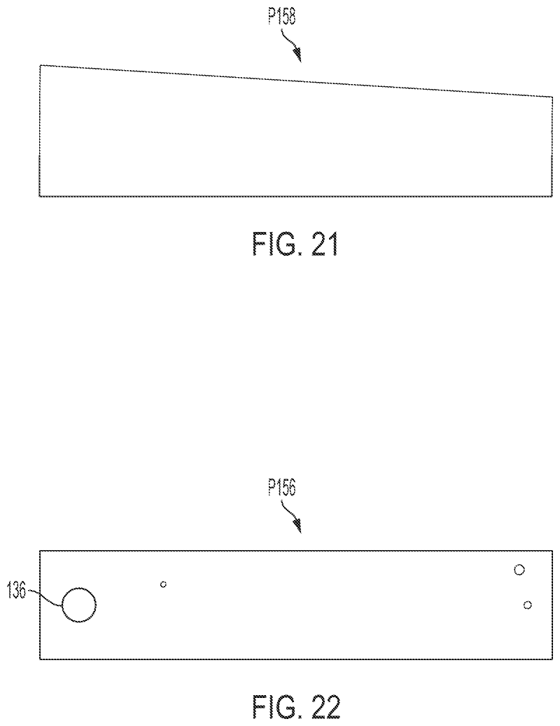

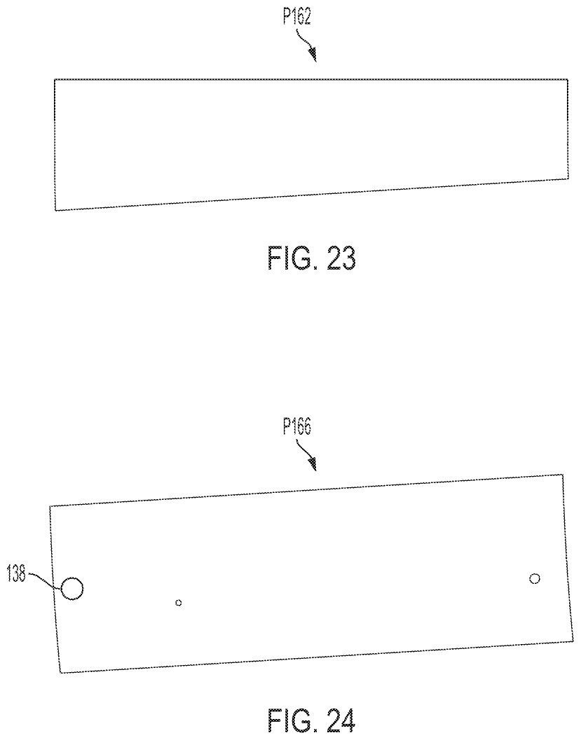

First, various flat preforms are provided for forming the front portion 122 and the rear portion 126 of the wall portion 110. For the front portion 122, these flat preforms include, as shown in FIG. 17, a first sidewall preform P142, as shown in FIG. 18, an upper wall preform P140, as shown in FIG. 19, a second sidewall preform P146 and, as shown in FIG. 20, a lower wall preform P150. For the rear portion 126, the flat preforms include, as shown in FIG. 21, a first sidewall preform P158, as shown in FIG. 22, an upper wall preform P156, as shown in FIG. 23, a second sidewall preform P162 and, as shown in FIG. 24, a lower wall preform P166. As illustrated, the sidewall preforms P142, P146, P158, and P162 have substantially right trapezoidal shapes. As illustrated, the upper wall preforms P140 and P156 have substantially rectangular shapes. As illustrated, the lower wall preforms P150 and P166 have substantially fan blade-like shapes (as used herein, meaning rectangular with one convex short end and one concave short end). Alternatively, the lower wall preforms P150 and P166 may have substantially rectangular shapes for ease of manufacturing. The upper wall preform P156 of FIG. 22 includes the inlet opening(s) 136 configured to communicate with the inlet(s) 114 (FIG. 1), and the lower wall preform P166 of FIG. 24 includes the outlet opening(s) 138 configured to communicate with the outlet(s) 116 (FIG. 1), although the placement of the inlet opening(s) 136 and the outlet opening(s) 138 may vary. One or more of the preforms P140, P142, P146, P150, P156, P158, P162, and P166 may be provided by cutting sheet metal stock.

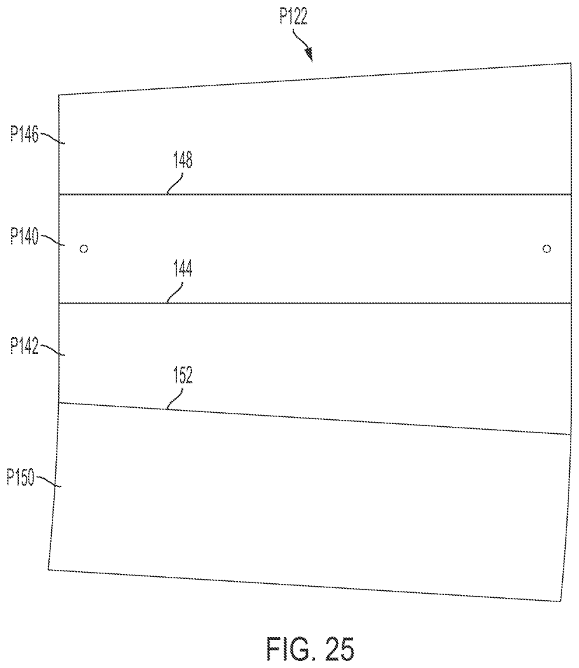

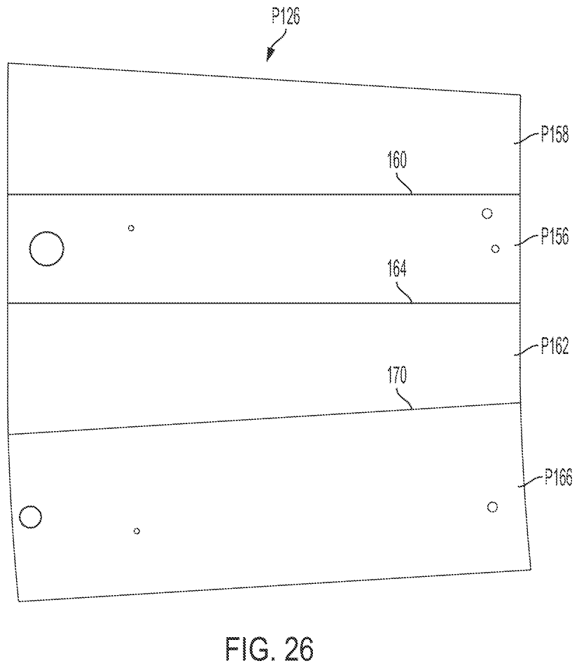

Next, the preforms P140, P142, P146, and P150 are coupled to provide, as shown in FIG. 25, a front portion preform P122 and the preforms P156, P158, P162, and P166 are coupled to provide, as shown in FIG. 26, a rear portion preform P126. More specifically, for the front portion preform P122 of FIG. 25, the first sidewall preform P142 is coupled to the upper wall preform P140 at the first seam 144, the upper wall preform P140 is coupled to the second sidewall preform P146 at the second seam 148, and the first sidewall preform P142 is coupled to the lower wall preform P150 at the third seam 152. For the rear portion preform P126 of FIG. 26, the first sidewall preform P158 is coupled to the upper wall preform P156 at the first seam 160, the upper wall preform P156 is coupled to the second sidewall preform P162 at the second seam 164, and the second sidewall preform P162 is coupled to the lower wall preform P166 at the fourth seam 170. The preforms P140, P142, P146, P150, P156, P158, P162, and P166 may be coupled via welding.

The front portion preform P122 and the rear portion preform P126 are then shaped to provide the front portion 122 and the rear portion 126, respectively. More specifically, the front portion preform P122 and the rear portion preform P126 are rolled on a metal rolling machine to shape the front portion 122 and the rear portion 126. The substantially uniform and, in some embodiments, equal radii of curvature R1, R4 (FIG. 12) and R5, R8 (FIG. 16) may simplify this rolling step, at least with respect to the corresponding upper walls 140, 156 and lower walls 150, 166. Next, for the front portion 122, the lower wall 150 is coupled to the first sidewall 142 at the fourth seam 154 (shown elsewhere) and for the rear portion 126 the lower wall 166 is coupled to the first sidewall 158 at the third seam 168 (shown elsewhere). The lower walls 150, 166 may be coupled to the first sidewalls 142, 158, respectively, via welding. Alternatively, the preforms P140, P142, P146, P150, P156, P158, P162, and P166 may be shaped prior to coupling them together.

The front portion 122 and the rear portion 126 are then coupled to each other at the intermediate seam 128 (shown elsewhere), for example, via welding. The front portion 122 and the rear portion 126 are ultimately coupled to the other components of the tank trailer 100, including the endwalls 120, 130 and the chassis 106 (shown elsewhere).

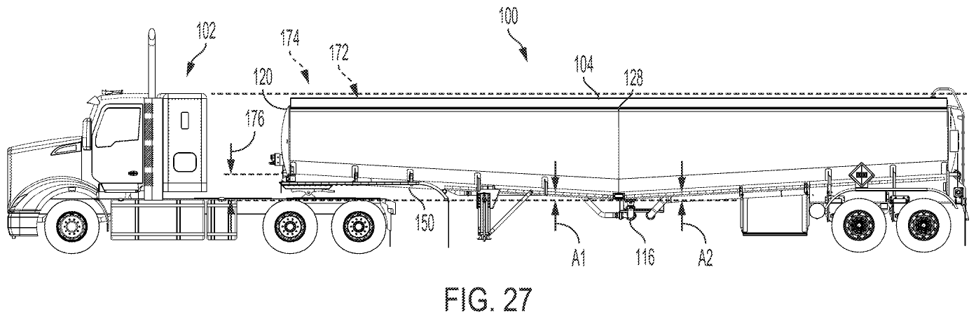

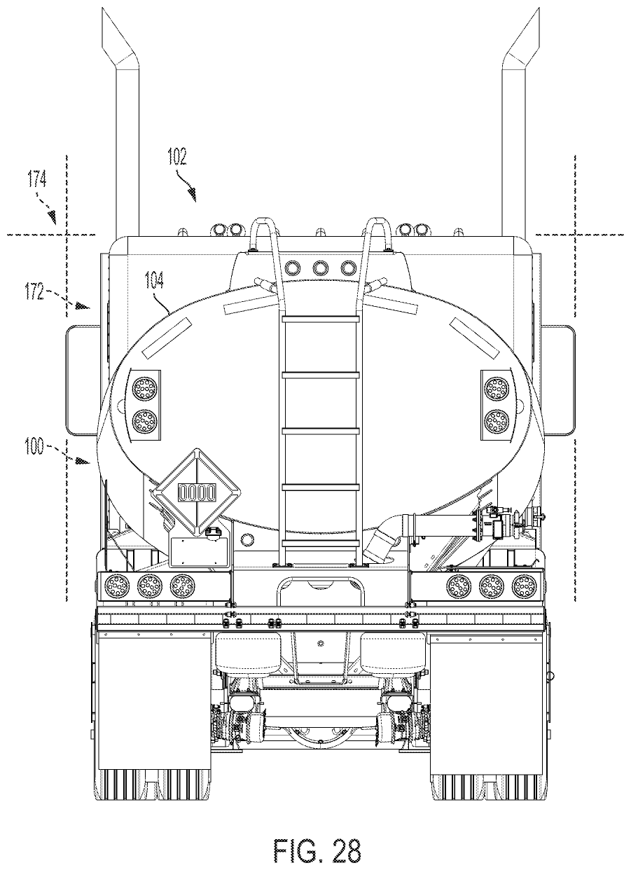

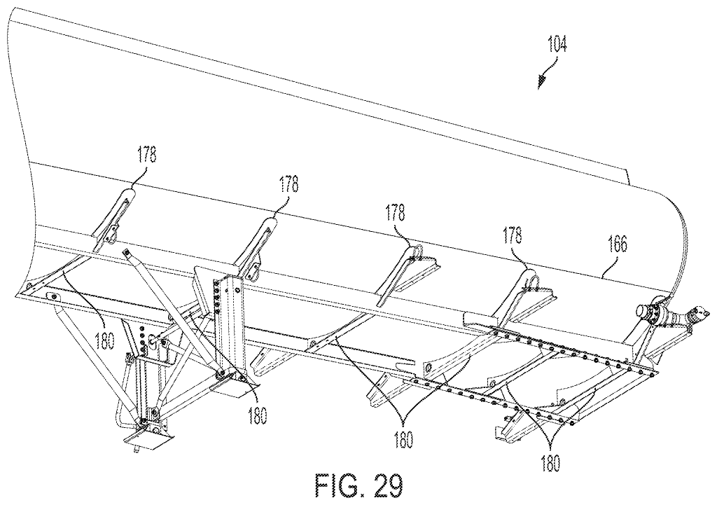

The shape of the tank 104 provides the tank trailer 100 with various advantages compared to other tank trailers. For example and referring now to FIGS. 27 and 28, the tank 104 has both a relatively high capacity and a relatively compact profile. More specifically, in the illustrated embodiment the tank 104 has a capacity of about 9800 gallons. The tank 104 has a maximum width of about 96 inches and a maximum height of about 68 inches and, as a result and as illustrated, the tank trailer 100 has a profile 172 that is substantially within the profile 174 of the conventional truck 102. The compact profile 172 of the tank trailer 100 facilitates, for example, improved maneuvering the tank trailer 100 compared to other tank trailers. As another example, the angles A1, A2 of the lower walls 150, 166, respectively, provide the tank 104 a relatively large elevation “drop” and pitch, which facilitates quickly and more completely dispensing cargo materials from the outlet 116. In the illustrated embodiment, the tank 104 has a drop 176 of about 14 inches, more specifically 14.25 inches, measured between an elevation of the lower wall 150 at the front wall 120 and an elevation of the lower wall 150 at the intermediate seam 128. The relatively large drop and the compact profile 172 also provide the tank trailer 100 and the cargo material with a relatively low center of gravity, which also facilitates improved stability and maneuvering for the tank trailer 100 compared to other tank trailers. The relatively large drop also permits relatively low positioning for the outlet 116, which facilitates easily coupling a hose to the outlet 116. As yet another example and referring to FIG. 29, the substantially uniform cross-sectional radii of curvature of the lower wall 166 and the lower wall 150 (shown elsewhere) of the tank 104 permit use of multiple chassis supports having similar sizes despite the “deep” conical shape. More specifically, the chassis 106 includes a plurality of the same or similarly-sized outriggers 178 and crossmembers 180 despite the conical shape. As yet another example, the method of manufacturing described above, in some embodiments, provides, by using rolled rectangles having a cylindrical radii (in contrast to typical varying conical radii), a double taper, double conical section tank with a varying circumference from the end to middle of the tank. The method of manufacturing described above includes relatively few cutting operations to provide the preforms P140, P142, P146, P150, P156, P158, P162, and P166. More specifically, relatively few or no cutting operations are used to provide the upper wall preforms P140 and P156 with their substantially rectangular shapes. Similarly, the shaping operations for the tank section preforms P122 and P126 are relatively simple, as noted above. As yet another example, the shape of the tank 104 also provides design modularity. More specifically, an increased capacity tank may be provided by projecting the shape of the front portion 122 forward and/or projecting the shape of the rear portion 126 rearward (that is, increasing the length of the tank 104) without changing the radii of the front portion 122 or the rear portion 126 from those described above. Conversely, a decreased capacity tank may be provided in the opposite manner. A method of manufacturing a plurality of tank trailers in view of this design modularity may include forming a first tank of a first length and with a first plurality of wall preforms. One or more of the preforms (for example, an upper wall preform and/or a lower wall preform) may have cross-sectional radii of curvature that are substantially uniform proceeding in a direction parallel to the longitudinal axis of the first tank. The method further includes forming a second tank of a second length that is different than the first length. The second tank is also formed with a second plurality of wall preforms. One or more of the preforms (for example, an upper wall preform and/or a lower wall preform) may have cross-sectional radii of curvature that are substantially uniform proceeding in a direction parallel to the longitudinal axis of the second tank. In addition, the cross-sectional radii of curvature may be equal to those of the first tank described above. In any case, various components of the chassis of such tanks, such as the outriggers, may have common shapes and/or sizes.

While the present invention has been described in the context of several embodiments, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

What is claimed is:

1. A tank trailer for transporting cargo material, the tank trailer comprising:
a chassis;
a plurality of wheels coupled to the chassis;
a tank coupled to the chassis, the tank comprising a wall portion defining a longitudinal axis of the tank and an internal chamber adapted to carry the cargo material, the wall portion comprising:
a first sidewall comprising a first cross-sectional radius of curvature that tapers proceeding in a direction parallel to the longitudinal axis;
a second sidewall; and
a third wall coupled to the first sidewall and the second sidewall, the third wall comprising a second cross-sectional radius of curvature that is substantially uniform proceeding in a direction parallel to the longitudinal axis.

2. The tank trailer of claim 1, wherein the third wall is a lower wall, and further comprising an upper wall coupled to the coupled to the first sidewall and the second sidewall opposite the lower wall.

3. The tank trailer of claim 2, wherein the lower wall is disposed at an acute angle relative to the longitudinal axis.

4. The tank trailer of claim 1, wherein the third wall is an upper wall, and further comprising a lower wall coupled to the coupled to the first sidewall and the second sidewall opposite the upper wall.

5. The tank trailer of claim 4, wherein the lower wall comprises a third cross-sectional radius of curvature that is substantially uniform proceeding in the direction of the longitudinal axis.

6. The tank trailer of claim 1, wherein the second sidewall comprises a third cross-sectional radius of curvature that tapers proceeding in the direction of the longitudinal axis.

7. The tank trailer of claim 1, wherein the wall portion further comprises an endwall coupled to the first sidewall, the second sidewall, and the third wall, the longitudinal axis intersecting the endwall, and the first cross-sectional radius of curvature tapering proceeding toward the endwall.

8. A tank trailer for transporting cargo material, the tank trailer comprising:
a chassis;
a plurality of wheels coupled to the chassis;
a tank coupled to the chassis, the tank comprising a wall portion defining a longitudinal axis of the tank and an internal chamber adapted to carry the cargo material, the wall portion comprising:
an upper wall;
a first sidewall coupled to the upper wall at a first seam, the first sidewall comprising a first cross-sectional radius of curvature that tapers proceeding in a direction parallel to the longitudinal axis;
a second sidewall coupled to the upper wall at a second seam opposite the first seam, the second sidewall comprising a second cross-sectional radius of curvature that tapers proceeding in the direction parallel to the longitudinal axis; and
a lower wall coupled to the first sidewall at a third seam and the second sidewall at a fourth seam opposite the third seam.

9. The tank trailer of claim 8, wherein the upper wall comprises a third cross-sectional radius of curvature that is substantially uniform proceeding in the direction parallel to the longitudinal axis.

10. The tank trailer of claim 8, wherein the lower wall comprises a fourth cross-sectional radius of curvature that is substantially uniform proceeding in the direction parallel to the longitudinal axis.

11. The tank trailer of claim 10, wherein the lower wall is disposed at an acute angle relative to the longitudinal axis.

12. The tank trailer of claim 11, wherein the acute angle is substantially 3 degrees.

13. The tank trailer of claim 11, wherein the acute angle provides the lower wall with an elevation drop of at least 14 inches.

14. The tank trailer of claim 8, wherein the wall portion of the tank comprises:
a front portion comprising the lower wall, the first sidewall, the second sidewall, and the upper wall;
a first endwall coupled to the front portion;
a rear portion coupled to the front portion opposite the first endwall, the rear portion comprising:
a rear upper wall;
a first rear sidewall coupled to the rear upper wall at a first rear seam, the first rear sidewall comprising a third cross-sectional radius of curvature that tapers proceeding in the direction parallel to the longitudinal axis;
a second rear sidewall coupled to the rear upper wall at a second rear seam opposite the first rear seam, the second rear sidewall comprising a fourth cross-sectional radius of curvature that tapers proceeding in the direction parallel to the longitudinal axis;
a rear lower wall coupled to the first rear sidewall at a third rear seam and the second rear sidewall at a fourth rear seam opposite the third rear seam; and
a second endwall coupled to the rear portion opposite the front portion.

15. The tank trailer of claim 14, wherein the lower wall is a front lower wall, and the front lower wall and the rear lower wall are disposed at acute angles relative to the longitudinal axis to provide the internal chamber with a lowest point at an interface between the front portion and the rear portion.

16. The tank trailer of claim 14, wherein the first, second, third, and fourth cross-sectional radii provide the internal chamber with a maximum cross-sectional area at an interface between the front portion and the rear portion.

17. The tank trailer of claim 8, wherein the wall portion further comprises an endwall coupled to the first sidewall, the second sidewall, the lower wall, and the upper wall, the longitudinal axis intersecting the endwall, the first cross-sectional radius of curvature tapering proceeding toward the endwall, and the second cross-sectional radius of curvature tapering proceeding toward the endwall.

18. A method of manufacturing a tank trailer for carrying cargo material, the method comprising:
forming a tank, comprising:
providing a first sidewall preform, a second sidewall preform, an upper wall preform, and a lower wall preform;
coupling the first sidewall preform to the upper wall preform at a first seam;
coupling the upper wall preform to the second sidewall preform at a second seam;
coupling the second sidewall preform to the lower wall preform at a third seam;
shaping the first sidewall preform, the upper wall preform, the second sidewall preform, and the lower wall preform to provide a tank section preform comprising a longitudinal axis, shaping the preforms comprising:
rolling the first sidewall preform to provide the tank section preform with a first sidewall comprising a first cross-sectional radius of curvature that tapers proceeding in a direction parallel to the longitudinal axis;
rolling at least one of the upper wall preform and the lower wall preform to provide the tank section preform with at least one of an upper wall and a lower wall comprising a second cross-sectional radius of curvature that is substantially uniform proceeding in the direction parallel to the longitudinal axis; and
mounting the tank to a chassis.

19. The method of claim 18, wherein shaping the preforms further comprises rolling the second sidewall preform to provide the tank section preform with a second sidewall comprising a third cross-sectional radius of curvature that tapers proceeding in the direction parallel to the longitudinal axis as a mirror image of the first cross-sectional radius of curvature.

20. The method of claim 18, wherein rolling at least one of the upper wall preform and the lower wall preform comprises:
rolling the upper wall preform to provide the tank section preform with the upper wall comprising the second cross-sectional radius of curvature that is substantially uniform proceeding in the direction parallel to the longitudinal axis; and
rolling the lower wall preform to provide the tank section preform with the lower wall comprising a third cross-sectional radius of curvature that is substantially uniform proceeding in the direction parallel to the longitudinal axis.

21. A method of manufacturing a plurality of tank trailers, the method comprising:
forming a first tank, comprising:
providing a first plurality of wall preforms;
coupling the first plurality of wall preforms to each other at a plurality of first seams;
shaping the first plurality of wall preforms to provide a first tank section preform comprising a first longitudinal axis and a first length in a first direction parallel to the first longitudinal axis, shaping the first plurality of preforms comprising rolling at least one of the first plurality of preforms to provide the first tank section preform with a first cross-sectional radius of curvature that is substantially uniform proceeding in the first direction parallel to the first longitudinal axis;
mounting the first tank to a first chassis;
forming a second tank, comprising:
providing a second plurality of wall preforms;
coupling the second plurality of wall preforms to each other at a plurality of second seams;
shaping the second plurality of wall preforms to provide a second tank section preform comprising a second longitudinal axis and a second length in a second direction parallel to the second longitudinal axis, the second length being different than the first length, shaping the second plurality of preforms comprising rolling at least one of the second plurality of preforms to provide the second tank section preform with a second cross-sectional radius of curvature that is substantially uniform proceeding in the second direction parallel to the second longitudinal axis, the second cross-sectional radius of curvature being equal to the first cross-sectional radius of curvature; and
mounting the second tank to a second chassis.

22. The method of claim 21, wherein the at least one of the first plurality of preforms comprises an upper wall preform.

23. The method of claim 21, wherein the at least one of the first plurality of preforms comprises a lower wall preform.
